(19) United States
(12) Patent Application Publication
(10) Pub. No.: US 2025/0283998 A1
(43) Pub. Date: Sep. 11, 2025

(54) Measuring Device

(71) Applicant: Robert Bosch GmbH, Stuttgart (DE)

(72) Inventors: Andreas Frischen, Leonberg (DE); Andreas Koelsch, Peiting (DE); Anke Giliard, Stuttgart (DE); Benjamin Moster, Niefern-Oeschelbronn (DE); Heiko Sgarz, Leonberg (DE); Jan Linus Steuler, Woelfersheim (DE); Lukas Fiederer, Balingen (DE); Uwe Troeltzsch, Roesrath (DE)

(21) Appl. No.: 19/071,470

(22) Filed: Mar. 5, 2025

(30) Foreign Application Priority Data
Mar. 11, 2024 (DE) 10 2024 202 230.6

(51) Int. Cl. G01S 13/88; G01S 7/06

(52) U.S. Cl. CPC G01S 13/888; G01S 7/06

(57) ABSTRACT

A measuring device, in particular a diagnostic device for walls, includes at least one radar sensor unit for providing radar data of a wall for which diagnostics are to be performed, a diagnostic module for performing wall diagnostics based on the radar data and for generating diagnostic results, and a display unit for displaying the diagnostic results to a user of the measuring device. The diagnostic module is configured to detect an object formed in the wall based on the radar data, wherein the object detection comprises a determination of an object position and a classification of an object type for the object.

This application claims priority under 35 U.S.C. § 119 to application no. DE 10 2024 202 230.6, filed on Mar. 11, 2024 in Germany, the disclosure of which is incorporated herein by reference in its entirety.

The present disclosure relates to a measuring device, in particular to a wall diagnostic device.

### BACKGROUND

Wall diagnostic devices for performing wall diagnostics and detecting objects formed in the walls are known from prior art.

The present disclosure provides an improved measuring device, in particular a wall diagnostic device.

### SUMMARY

According to one aspect, a measuring device is provided, in particular a diagnostic device for walls, comprising at least one radar sensor unit for providing radar data of a wall for which diagnostics are to be performed, a diagnostic module for performing wall diagnostics based on the radar data and for generating diagnostic results, and a display unit for displaying the diagnostic results to a user of the measuring device, wherein the diagnostic module is configured to detect an object formed in the wall based on the radar data, wherein the object detection comprises a determination of an object position and a classification of an object type for the object.

This thus achieves the technical advantage that an improved measuring device can be provided, in particular a wall diagnostic device. The measuring device is preferably configured as a wall diagnostic device, by means of which walls to be examined can be examined. In particular, the wall diagnostic device is configured to detect objects located in the wall. For this purpose, the measuring device comprises at least one radar sensor unit, by means of which radar signals can be transmitted towards a wall to be examined and radar signals reflected at the front of the wall can be received. Furthermore, the measuring device comprises a diagnostic module configured to execute on the radar data of the radar sensor unit and to perform wall diagnostics based thereon.

The diagnostic module is configured to perform object detection of objects arranged in the wall to be examined based on the radar data of the radar sensor unit. The object recognition comprises at least one object detection and one object classification.

The object detection comprises detecting an object located in the wall and determining an object position of the object within the wall. The object classification comprises determining object classes, with which the detected object is to be associated. With the object classification, object types of the detected object may be unambiguously determined. In addition, the measuring device comprises a display unit. On the display unit, which may be configured as a display, for example, the diagnostic results of the wall diagnostics, i.e., an object position and/or an object type of the detected and classified object located in the wall, can be displayed to a user.

The measuring device according to the disclosure has the advantage that an unambiguous classification of the detected objects, i.e., a clear association of object types with the detected objects, can be carried out exclusively based on radar data of a radar sensor unit of the measuring device. Additional information, for example measured values of additional measurement variables of additional sensor elements, is not necessary for object recognition in the sense of the present disclosure.

According to one embodiment, the diagnostic module is further configured to determine an object depth of the object within the wall based on the radar data, wherein the object depth is defined by a distance of the object formed in the wall to a surface of the wall.

The technical advantage can thereby be achieved that, based on the radar data of the radar sensor unit, an object depth of the object within the wall can be determined by the measuring device in addition to the object recognition. The object depth describes a distance of the object to a surface of the wall. The correspondingly configured diagnostic module may determine the object depth based solely on the radar data of the radar sensor unit.

According to one embodiment, the diagnostic module is further configured to determine an object extension of the object in a predefined direction based on the radar data.

The technical advantage can thereby be achieved that an object extension of the object detected in the wall is further enabled based on the radar data of the radar sensor unit. The object extension describes an extension of the object at least with respect to one spatial direction, preferably with respect to two spatial directions, especially preferably with respect to three spatial directions. This allows for one-dimensional, preferably two-dimensional, more preferably three-dimensional extension information for the object located in the wall.

According to one embodiment, the diagnostic module is further configured to classify a wall type of the wall based on the radar data.

The technical advantage can thereby be achieved that, in addition to object recognition, wall type classification can also be performed based solely on the radar data from the radar sensor unit. In the wall type classification, various wall types of the walls to be examined can be determined or classified by the correspondingly configured diagnostic module. Due to the fact that the wall type is classified automatically, the user does not have to enter the respective wall type of the wall to be examined as additional information for the wall diagnostics, as is known from prior art. Instead, the wall type is automatically determined by the diagnostic module based on the radar data from the radar sensor unit.

The wall type may be incorporated into the wall diagnostics and object recognition as additional information, for example for background correction. Alternatively or additionally, the detected wall type may be displayed to the user in the display unit as additional information in the diagnostic result.

According to one embodiment, the diagnostic module is further configured to perform a subsurface correction for object recognition based on the wall type classification.

The technical advantage can thereby be achieved that more precise object detection may be realized by considering the wall type classification of the wall to be examined in a subsurface correction of the radar data of the radar sensor unit. Different wall types provide different radar signals reflected by the wall. When taking the respective wall type into consideration in the form of a subsurface correction, these effects of the different wall types on the radar signals can be taken into account. This allows for false object recognition due to the wall type to be avoided and allows for more precise detection of the objects located in the wall.

According to one embodiment, the display unit is configured to display to the user the object position of the object in the wall and a type class of the object type of the object and/or an object depth and/or an object extension of the object and/or a type class of the wall type of the wall as a diagnostic result.

The technical advantage can thereby be achieved that a variety of different information regarding the wall to be examined may be provided to the user in the display of the measuring device. The user thus has the essential results of the wall diagnostics at a glance in the display unit and can carry out the planned work on the wall based on this.

According to one embodiment, the diagnostic module comprises at least a pre-processing module, a wall type classification module and an object recognition module, wherein the pre-processing module is configured to pre-process the radar data of the radar sensor unit and provide input data for the wall type classification module and the object recognition module, wherein the wall type classification module is configured to classify the wall type of the wall based on the input data provided by the pre-processing module, and wherein the object recognition module is configured to detect the object formed in the wall and classify the respective type of object of the object based on the input data provided by the pre-processing module.

The technical advantage can thereby be achieved that precise wall diagnostics are enabled by the correspondingly configured diagnostic module using the radar data of the radar sensor unit. By pre-processing the radar data of the radar sensor unit, the radar data can be brought into the form required for wall diagnostics. Using a correspondingly configured wall type classification module, a corresponding wall type classification can be performed on the pre-processed radar data, and the respective wall type of the wall can be determined.

An object recognition of an object located in a wall may be performed by an object recognition module based on the pre-processed radar data and taking into account the wall type provided by the wall type classification module. The object recognition module is configured to perform an object detection and object classification of the object located in the wall based on the pre-processed radar data and taking into account the provided wall type. The presented architecture of the diagnostic module allows for the most precise and reliable wall diagnostics of walls to be examined.

According to one embodiment, the diagnostic module comprises at least a first pre-processing module and a second pre-processing module, wherein the first pre-processing module is configured to pre-process the radar data of the radar sensor unit and provide the input data for the wall type classification module, wherein the wall type classification module is configured to classify the wall type of the wall based on the input data provided by the first pre-processing module and provide wall type information to the second pre-processing module, wherein the second pre-processing module is configured to pre-process the radar data of the radar sensor unit and, taking into account the wall-type information of the wall-type classification module, provide the input data to the object recognition module, and wherein the object recognition module is configured to detect the object formed in the wall and classify the respective type of object of the object based on the input data provided by the second pre-processing module.

The technical advantage can thereby be achieved that the first pre-processing module and the second pre-processing module enable more precise pre-processing of the radar data of the radar sensor unit. The presented architecture of the diagnostic module thus enables further precise object recognition and thus further precise wall diagnostics.

According to one embodiment, the measuring device further comprises at least one of an induction sensor and/or an eddy current sensor and/or a capacitance sensor and/or an AC current sensor and/or a nuclear magnetic resonance (NMR) sensor and/or an ultrasonic sensor for providing additional sensor data, wherein the diagnostic module is configured to perform the wall diagnostics by taking into account the additional sensor data.

The technical advantage can thereby be achieved that, through further sensor data, additional sensors, each of which is configured to detect different physical variables, can provide additional information in addition to the radar data of the radar sensor unit, for incorporation into the wall diagnostics. This additional information, which is preferably complementary to the information of the radar data of the radar sensor unit, allows further precise specification of the wall diagnostics and the object recognition, respectively.

According to one embodiment, the diagnostic module comprises at least one correspondingly trained artificial intelligence structure configured to perform an object recognition and/or wall classification and/or object depth determination based on the radar data and/or the additional sensor data.

The technical advantage can thereby be achieved that, because the diagnostic module is configured as a correspondingly trained artificial intelligence structure, which is trained based on the radar data, or, if applicable, taking into account the information of the additional sensors, to perform an object recognition and/or a wall classification and/or an object depth determination and/or an object extension determination, a reliable and powerful diagnostic module can be provided. By using the artificial intelligence technology, precise wall diagnostics can be provided.

According to one embodiment, the measuring device further comprises a motion detection unit, wherein the motion detection unit is configured to sense movement of the measuring device along the surface of the wall.

The technical advantage can thereby be achieved that a movement of the measuring device relative to the wall can be determined by the motion detection unit. In the customary use of wall diagnostic devices, the wall diagnostic device is moved by the user along the length of the wall, on which the diagnostics are performed. The corresponding relative movement of the measuring device relative to the wall can be determined by the motion detection unit. Based on this determined relative movement, the wall diagnostics may be performed for different positions of the measuring device relative to the wall. This allows a surface examination of the wall to be examined and allows the recognition of objects and the determination of extension of objects over a range that is substantially larger than the effective range of the radar sensor unit.

The motion detection unit thus allows wall diagnostics while the measuring device is moving relative to the wall, as a result of which a larger area of the wall to be examined can be covered and the wall diagnostics can be accelerated accordingly.

According to one embodiment, object classes of the detected object comprise: metallic/non-metallic object, low voltage cable, single phase AC signal cable, multiphase AC signal cable, wood beam, metal beam, plastic pipe, water filled plastic pipe, for example fresh water pipe, non-water filled plastic pipe, for example waste water pipe, and/or wherein the wall type classes of the wall comprise: Concrete wall, plasterboard/drywall wall, brick wall and/or bricks of the wall, underfloor heating, wall heating.

The technical advantage may thereby be achieved that a large number of different objects of different object types can be detected or classified. The measuring device or the diagnostic module can be trained hereby to detect and classify common objects installed in building walls. This allows particularly precise wall diagnostics, in which the detected objects can be precisely and unambiguously assigned to the corresponding object classes.

By precisely classifying objects and providing the corresponding classification information to the user via the display unit, wall diagnostics are made as meaningful as possible. Since the user not only knows that an object is located within the wall and where it is, but also which object type the detected object is, the user can decide accordingly how to carry out further work on the wall with respect to the detected object. Providing the object types of the object classification of the detected objects thus represents an essential area of the wall diagnostics, because the user can adjust the planned work on the wall based on the indicated object type accordingly.

### BRIEF DESCRIPTION OF THE DRAWINGS

Embodiments of the disclosure are described with reference to the following figures. The figures show:

FIG. 1 a schematic illustration of a measuring device according to one embodiment;

FIG. 2 a further schematic illustration of the measuring device according to a further embodiment;

FIG. 3 a further schematic illustration of the measuring device according to a further embodiment;

FIG. 4 a schematic illustration of a measurement of the measuring device according to one embodiment, and

FIG. 5 a further schematic illustration of the measuring device according to a further embodiment.

### DETAILED DESCRIPTION

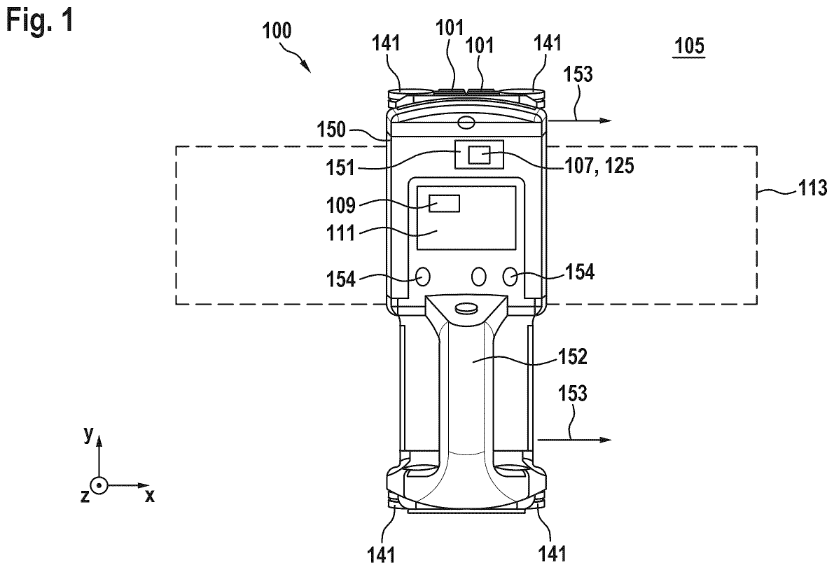

FIG. 1 shows a schematic illustration of a measuring device 100 according to one embodiment.

The present disclosure relates to a measuring device, in particular a wall diagnostic device for examining walls 105 to be worked on. Wall diagnostic devices are known from prior art that are used to detect objects located in walls. Such devices allow a user to examine walls to be worked on to search for objects located in the walls, in order to be able to perform planned work, for example drilling in walls, such that damage to the objects located in the walls can be avoided.

In the embodiment shown, the measuring device 100 comprises a housing 150 having a handle 152 for grasping of the measuring device 100 by a user, a display unit 111 for displaying diagnostic results 109 of the wall diagnostics, and controls 154 for switching the measuring device 100 between various operating modes.

According to the disclosure, the measuring device 100 comprises at least one radar sensor unit 101. By means of the radar sensor unit 101, radar signals may be transmitted towards the wall 105 to be examined, and radar signals reflected by the wall 105 may be received.

For example, the radar sensor unit 101 may be configured as a narrow band radar detector device in the 2.4 GHz to 2.4835 GHz frequency range or as an ultra-wide band radar detector device in the 1.8 GHz to 5.8 GHz frequency range.

The measuring device 100 further comprises a diagnostic module 107 executable on a computing unit 151 of the measuring device 100 to perform the wall diagnostics. The diagnostic module 107 is configured to perform corresponding diagnostics on the wall to be examined based on the radar data 103 of the radar sensor unit 101. The radar data 103 of the radar sensor unit 101 thereby depicts the wall 105 to be examined and, if applicable, objects 113 located within the wall 105.

The wall diagnostics carried out by the diagnostic module 107 comprise at least performing object recognition. The object recognition comprises an object detection and an object classification of the object 113 located in the wall 105. The object detection comprises at least the determination of an object position 115. The object position describes the positioning of the object located in the wall 105 with respect to a reference system defined by the measuring device 100. The object classification of the detected object 113 comprises at least determining an object type 117 of the detected object 113.

The diagnostic results of the wall diagnostics determined in this way, i.e. at least the determined object position 115 and/or the determined object type 117 of the object 113 located in the wall 105, are subsequently presented in a display unit 111 of the measuring device 100 to a user of the measuring device 100. For example, the display unit 111 may be configured as a corresponding display, and the diagnostic results 109 may be visually displayed. Additionally, the display of the diagnostic results 109 may be supported via audible and/or haptic signals. For example, the haptic signals may be realized via corresponding vibration signals.

The object 113 can be shown in the display, for example, by means of a corresponding icon. The object 113 can be shown in the corresponding object position 115 in the display. The object extension 121 may be visualized by a corresponding size of the displayed icon. The particular object type 117 of the object 113 may be visualized with a corresponding term or color highlighting of the icon, or by a specific shape of the icon representing the object 113.

Alternatively, the wall diagnostics may additionally comprise determining a wall type 123 in the form of a wall type classification of the wall 105 to be examined. The wall type 123 describes the respective type of the wall 105 to be examined. For example, the wall type may be associated with corresponding wall type classes, which may comprise: Concrete wall, plasterboard/drywall wall, brick wall and/or wall bricks, underfloor heating, wall heating or similar wall types found in buildings.

According to one embodiment, the diagnostic module 107 is further configured to determine an object depth 119 of the object 113 within the wall 105 based on the radar data 103. The object depth 119 is defined by a distance of the object formed in the wall 105 to a surface of the wall 105. The distance may be defined on the object side, for example with respect to an object surface or with respect to an object center point. The distance to the surface of the wall 105 describes a shortest distance defined by a direction perpendicular to the surface of the wall 105.

According to one embodiment, the diagnostic module 107 is further configured to determine an object extension 121 of the object 113 in at least one predefined direction based on the radar data 103. The object extension 121 of the object 113 describes a spatial extension of the object 113 in at least one spatial direction, preferably in two spatial directions, particularly preferably in three spatial directions. The object 113 may be described here as a one-dimensional, two-dimensional, or three-dimensional object 113.

In conventional use, the measuring device 100 is placed on the surface of the wall 105 to be examined. Radar signals are transmitted towards the wall 105, and radar signals reflected from the wall 105 or the objects 113 located behind it are received, via the radar sensor unit 101. This radar data 103 of the radar sensor unit 101 is used by the diagnostic module 107 to perform the wall diagnostics described above and to determine corresponding diagnostic results 109.

For example, the diagnostic results 109 may comprise the object position 115 and/or object type 117 of the object 113 located in the wall 105. Alternatively or additionally, the diagnostic results 109 may comprise the wall type 123 of the wall 105 and/or the object depth 119 and/or the object extension 121 of the object 113.

The diagnostic results 109 configured in this manner may subsequently be displayed to a user of the measuring device 100 in a display unit 111 of the measuring device 100. The display unit 111 can be configured as a corresponding display, for example. The diagnostic results 109 may be displayed in graphical or textual form in the display unit 111.

According to one embodiment, the measuring device 100 further comprises a motion detection unit 141. The motion detection unit 141 may be used to detect movement of the measuring device 100 relative to the wall 105. The motion detection unit 141 may comprise, for example, at least one roller element for this purpose. When the roller element is placed on the wall surface of the wall 105, movement of the measuring device 100 relative to the wall 105 can be detected when the measuring device 100 moves along a direction of movement 153 by rolling the roller element. Alternatively, the motion detection unit 141 may have a different configuration by which a relative movement of the measuring device 100 relative to the wall 105 can be detected.

By moving the measuring device 100 relative to the wall 105, radar data 103 of the radar sensor unit 101 may be captured for a plurality of different positions of the measuring device 100 relative to the wall 105. This allows a larger spatial area of the wall 105 to be examined than the effective range of the radar sensor unit 101. This allows for objects 113 to be captured that have a greater spatial extent than the effective range of the radar sensor unit 101.

While the measuring device 100 moves along the direction of movement 153, radar data 103 of the radar sensor unit 101 may be captured continuously. The wall diagnostics may be evaluated by the diagnostic module 107 based on this radar data 103 while the measuring device 100 is moving along the direction of movement 153. This allows for accelerated wall diagnostics, taking into account the positioning of the measuring device 100 relative to the wall 105.

According to its embodiment, the diagnostic module 107 is configured as a correspondingly trained artificial intelligence 125. The artificial intelligence 125 is trained to perform the above-mentioned wall diagnostics based on the radar data 103 of the radar sensor unit 101 and to determine at least the object position 115 and the object type 117 of an object 113 located in the wall 105. The object classification or determination of the object type 117, respectively, comprises assigning the detected object 113 to predefined object classes.

The object classes may comprise: Metallic/non-metallic object, low voltage cable, single phase AC signal cable, multiphase AC signal cable, wood beam, metal beam, plastic pipe, water filled plastic pipe, for example fresh water pipe, non-water filled plastic pipe, for example waste water pipe, or other elements commonly installed in building walls.

Furthermore, the artificial intelligence 125 may be trained to determine the wall type 123 of the wall 105 to be examined at least based on the radar data 103 of the radar sensor unit 101. Possible wall types 123 may comprise: Concrete wall, plasterboard/drywall wall, brick wall and/or individual bricks of the brick wall, underfloor heating, wall heating or other similar wall types commonly installed in buildings.

According to one embodiment, in addition to the radar sensor unit 101, the measuring device 100 may comprise further additional sensors by means of which additional physical variables are detectable. For example, the measuring device 100 may comprise an induction sensor and/or an eddy current sensor and/or a capacitance sensor and/or an AC current sensor and/or an NMR sensor and/or an ultrasonic sensor or other sensors commonly used in wall diagnostic devices.

The diagnostic module 107, in particular the corresponding trained artificial intelligence 125, can be configured to perform wall diagnostics based on the radar data 103 of the radar sensor unit 101 and taking into account the additional sensor information of the further sensors described above. The additional information of the additional sensors mentioned above can particularly be used for object recognition of the objects 113 located in the walls 105. The additional sensor information may possibly provide improved detection of the objects 113 and may possibly provide improved classification of the objects 113.

For example, the material of the objects 113, for example as a metallic or non-metallic material, can be particularly improved and classified by using the additional sensor information.

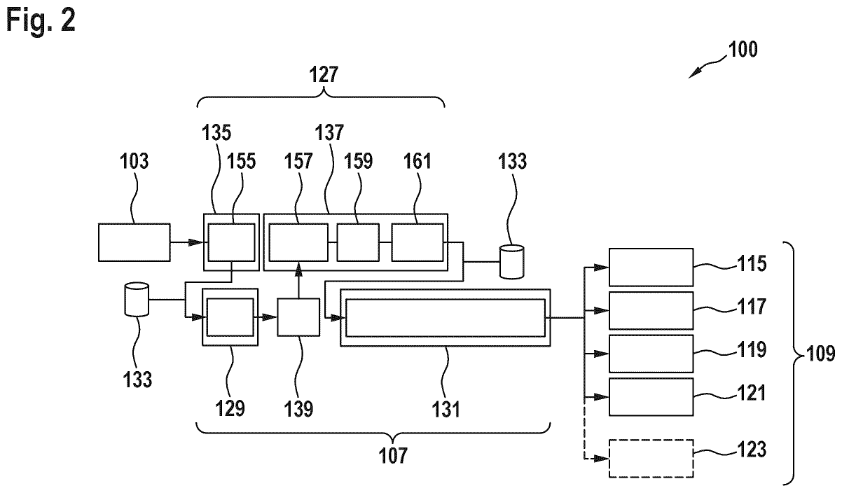

FIG. 2 shows another schematic representation of the measuring device 100 according to a further embodiment.

In the embodiment shown, the measuring device 100 comprises a pre-processing module 127 in addition to the diagnostic module 107. For wall diagnostics, the measuring device 100 first receives the radar data 103 of the radar sensor unit 101. Pre-processing of the receiving radar data 103 is performed via the pre-processing module 127. For example, via pre-processing by the pre-processing module 127, the radar data may be brought into a corresponding data structure required for wall diagnostics by the diagnostic module 107.

As described above, during wall diagnostics, the diagnostic module 107 generates the diagnostic results 109 described above. For example, the diagnostic results 109 may comprise the object position 115 and/or object type 117 and/or object depth 119 and/or object extension 121 of an object 113 formed in the wall 105 to be examined and/or the wall type 123 of the wall 105 to be examined. The correspondingly generated diagnostic results 109 may subsequently be displayed in the display unit 111 of the measuring device 100.

According to one embodiment, in addition to the radar data 103 of the radar sensor unit 101, the additional sensor information of the additional sensors described above may be considered during the wall diagnostics of diagnostic module 107. A corresponding pre-processing of the additional sensor information may be performed accordingly by the pre-processing module 127.

In the embodiment shown, the diagnostic module 107 comprises a wall type classification module 129 and an object recognition module 131. The pre-processing module 127 comprises a first pre-processing module 135 and a second pre-processing module 137. The first pre-processing module 135 comprises an S matrix reduction 155. The second pre-processing module 137 comprises a background correction 157, an inverse Fast Fourier transformation 159, and a focusing and migration 161. During the pre-processing of the radar data 103 by the pre-processing module 127, the radar data 103 is first pre-processed by the first pre-processing module 135 and the S-matrix reduction 155 contained therein.

When doing so, the first pre-processing module 135 generates input data 133 based on the radar data 103. The input data 133 serves as input data for the wall type classification module 129. The wall type classification module 129 performs a wall type classification of the wall 105 to be examined based on the input data 133 and generates wall type information 139. The wall type information 139 contains the wall type 123 of the wall 105 to be examined, as determined in the wall type classification.

Subsequently, the second pre-processing module 137 performs pre-processing based on the radar data 103 and the wall type information 139. A background correction 157 of the radar data 103 is performed during this, taking into account the wall type 123 determined in the wall type information 139. Depending on the wall type 123 of the wall 105 to be examined, different effects can occur on the radar data 103.

These effects, which are primarily based on the respective wall type 123 and can affect object recognition, can be corrected by the background correction 157. After the background correction has been performed, further pre-processing can be carried out by performing the inverse Fast Fourier transformation 159 or focusing and migration 161, respectively, and input data 133 can be created for the object recognition module 131 once again. Based on the input data 133 provided by the second pre-processing module 137, the object recognition module 133 performs object recognition of the object 113 located in the wall 105 to be examined and determines at least the object position 115 and the object type 117 of the respective object 113. Additionally, the object depth 119 and the object extension 121 may be determined by the object recognition module 131.

According to one embodiment, the diagnostic module is further configured to determine an object depth of the object within the wall based on the radar data, wherein the object depth is defined by a distance of the object formed in the wall to a surface of the wall.

The pre-processing is optional. Depending on the algorithm used for the diagnostic module 107, completely unprocessed radar echoes of different frequencies may be used as radar data 103 and as input data for the diagnostic module 107. Alternatively, radar data 103 processed via multiple steps may be used. The pre-processing steps comprise, for example, the transformation of the signals from the frequency domain to the time or distance domain, background deduction, noise removal, and normalization of the signals. For radar data 103 which is available in the form of complex numbers, only the absolute value can be processed. Alternatively or additionally, the phase information may be considered.

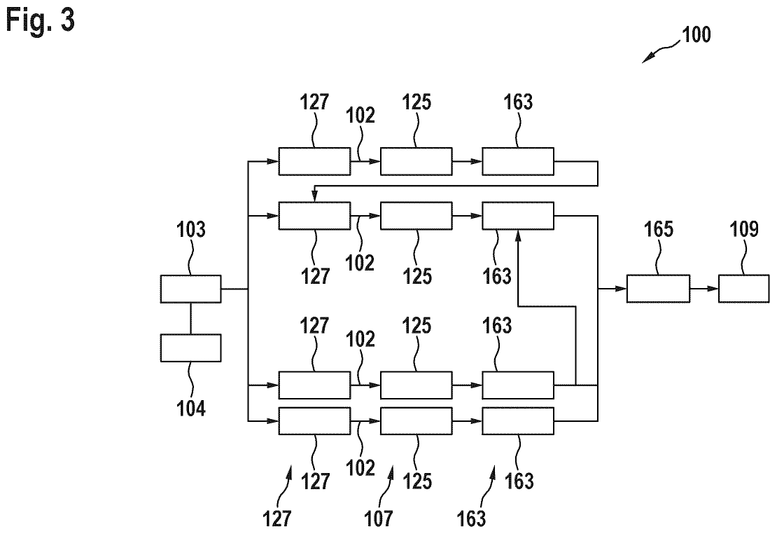

FIG. 3 shows a further schematic representation of the measuring device 100 according to a further embodiment.

In the embodiment shown, the diagnostic module 107 comprises a plurality of parallel processing paths 102. Each processing path 102 comprises a pre-processing module 127, the diagnostic module 107, comprising the wall type classification module 129 and/or the object recognition module 131, for example, according to the embodiment in FIG. 2, and a post-processing module 163.

In FIG. 3, primarily the radar data 103 is shown as input data for the wall diagnostics. In addition to the radar data shown, however, the additional information from the additional sensors may also serve as input data for the wall diagnostics. The different information from the different types of sensors in the different parallel processing paths 102 can be processed and the corresponding wall diagnostics performed separately on the different sensor information. Upon completion of the wall diagnostics, a summary module may be used to assemble a summary of the individual partial analysis results for the diagnostic results 109 of the wall diagnostics.

Alternatively or additionally, different sub-aspects of wall diagnostics may be performed by the different processing paths 102 based on the same sensor information.

For example, the individual processing paths 102 may process different radar data 103 captured during movement of the measuring device 100 relative to the wall 105 for different positions of the measuring device 100 relative to the wall 105. The radar data 103, thus representing different regions of the wall 105 and captured sequentially in time as the measuring device 100 moves relative to the wall 105, may then be processed in the different processing paths 102 by the modules shown.

The various processing paths perform stand-alone wall diagnostics including at least determining the object position 115 and/or the object type 117 of the object 113 located in the wall 105.

By means of the summary module 165, the partial results of the stand-alone wall diagnostics of the different regions of the wall 105 provided in the individual processing paths 102 can be summarized to a contiguous diagnostic result 109. The contiguous diagnostic result describes the wall diagnostics of a contiguous spatial area that was scanned during movement of the measuring device 100 relative to the wall 105 and depicted by the corresponding captured radar data 103. The parallel processing of the radar data 103 or additional sensor information 104 of the additional sensor elements in the different processing paths 102 thus enables accelerated wall diagnostics.

Alternatively, various wall diagnostic functions may also be performed in the different processing paths 102. For example, in one processing path 102, the wall type classification and the determination of the wall type 123 of the wall 105 to be examined can be performed. In another processing path 102, object recognition of the object 113 located in the wall can be performed. The object detection can be performed with the determination of the object position 115 and the object classification can be performed with the determination of the object type 113 in one processing path 102.

Alternatively, the object detection and object classification may then also be performed in two separate processing paths 102. In further processing paths 102, the object depth determination, i.e., the determination of the object depth 119 and/or the determination of the object extension 121 may each be carried out. In the summary module 165, the various partial results of the wall diagnostics may be summarized into corresponding diagnostic results 109.

The diagnostic module 107 can be divided into different artificial intelligence structures 125, as already shown in the embodiment in FIG. 2. For example, the diagnostic module 107 may comprise a wall type classification module 129 and an object recognition module 131. The object recognition module may in turn be divided into an object detection module and an object classification module. The diagnostic module 107 may further comprise an object depth determination module and object extension module, respectively configured to determine the object depth 119 and the object extension 121.

The respective modules may each be configured as stand-alone artificial intelligence structures 125, for example, neural networks. Alternatively, the various modules may form portions of an overall artificial neural network that are connected to an overall neural network according to structures known from prior art.

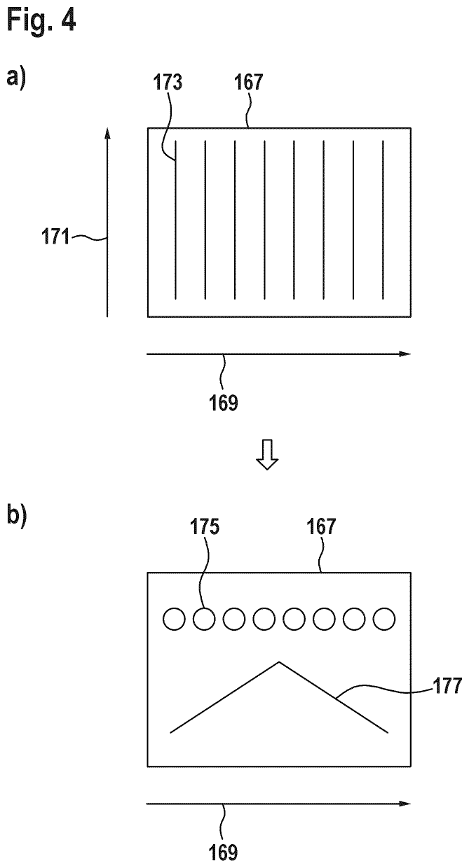

FIG. 4 shows a schematic illustration of a measurement by the measuring device 100 according to one embodiment.

For pre-processing, the radar data 103 or the additional sensor information 104 of the remaining sensors may be normalized, in particular to numerically stabilize the subsequent steps performed by the diagnostic module 107 during the wall diagnostics. For example, an amplitude and/or offset compensation may be performed for this purpose. Moreover, to reduce interference, filtering of the radar data 103 may be carried out, and to reduce the data rate, the corresponding sensor data may be sampled. Additionally, the radar data 103 or the additional sensor information 104 may be transformed into the respectively required frequency range or time range. Methods known from prior art can be used for this purpose.

Furthermore, the captured radar data 103 or additional sensor information 104 may be divided into temporal or spatial windows 167. Temporal windows 167 may be generated by recording the radar data 103 or the additional sensor information or the pre-processed radar data 103 over a fixed time interval. Spatial windows 167, on the other hand, may be generated from a mapping of the radar data 103 or additional sensor information 104 to positions of the measuring device 100 relative to the wall 105 along the direction of movement 153.

Graph a) of FIG. 4 shows such a data matrix resulting from the steps described above. The data matrix of the window 167 shown in graph a) shows a plurality of sensor data, which may comprise, for example, radar data 103 or additional sensor information 104 of the further sensors plotted along a frequency channel axis 171 or along a space/time axis 169, respectively.

A width of the temporal windows 167 may be selected such that different sampling rates of the sensors may be balanced and a new window 167 may be provided frequently enough so that a display of the diagnostic results 109 of the wall diagnostics in the display unit 111 may be shown without too great of a time delay while the measurement is being performed or shortly after the measurement by the measuring device 100 ends.

A rate of 2 to 20 windows per second of the data recording of the sensor data may be advantageous for this purpose. For spatial windows, the spatial sampling rates can be selected to achieve the desired local accuracy. Advantageously, 1 mm to 1 cm sampling rates can be used. This means that corresponding sensor data is captured every 1 mm to 1 cm of movement of the measuring device 100 along the direction of movement 153.

A width of the spatial windows 167 may be selected such that contiguous information relating to an object 113 is contained in a window. Advantageously, a width of the respective spatial windows 167 can be 1 cm to 20 cm. This results in 4 to 100 measured values per window 167. This allows for further efficient algorithmic processing of the correspondingly recorded radar data 103 or additional sensor information by the diagnostic module 107.

A further temporal window 167 or spatial window 167 can be provided as soon as one or more sampling points are available.

The diagnostic module 107 may be oriented such that a matrix corresponding to the window size of the respective spatial or temporal window 167 may be included as input data, for example of each processing path 102 of the embodiment in FIG. 3 as well. According to the embodiment in FIG. 2, the corresponding input data can comprise the respective pre-processed sensor data, i.e. radar data 103 and additional sensor information 104 of the additional sensors.

As stated above, the wall diagnostics may be performed by the diagnostic module 107 based on a correspondingly trained artificial intelligence. Alternatively, different processing paths may also be calculated by means of rule-based algorithms. In addition, within a processing path 102, a combination of artificial intelligence and rule-based algorithm is possible in the form of a parallel operation or concatenation.

The diagnostic results 109 of the wall diagnostics may be expressed as numeric values, vectors, or matrices. Furthermore, for the object detection, the probability of detection, or for the wall type classification and/or the object classification, respectively, a probability of the specified object classes and/or wall type classifications can be indicated. The same may apply to the position and/or depth determination, for which corresponding probability values can also be indicated.

In addition to the radar data 103, if the additional sensor information of the further sensor types is processed in a processing path 102, these may either be merged within the artificial intelligence 125 or combined by means of rule-based combinations.

During the post-processing of each processing path 102, of the embodiment in FIG. 3, multiple algorithm results based on multiple windows 167 may be summarized by the summary module 165. This summary can in particular be realized by means of majority formation, sum formation or also by multiplication of successive probability values.

Furthermore, by clustering multiple results, for example, it is possible to detect which objects, of multiple detected objects located close to one another, are the same object so that they are not incorrectly detected multiple times.

Likewise, it is possible to multiplicatively apply a weighting function 177 when summarizing the results from multiple windows 167. Advantageously, the diagnostic partial results 175 corresponding to corresponding data points in the space may be weighted with respect to positioning of the diagnostic partial results 175 relative to a center point of the respective window 167. This is illustrated by way of example in graph b), in which the individual diagnostic partial results 175 are weighted according to the weighting function 177 shown with respect to the center point of the window 167 shown.

According to one embodiment, the results of one processing path 102 after post-processing 163 may influence the extension of another processing path 102. Weighting parameters may be adjusted that may depend on the particular result from the processing path 102 for each window.

For example, the result of an object classification in which the object type 117 of an object located in the wall 105 is defined, can be used to increase the weight of a wall type classification, in which the wall type 123 of the respective wall 105 is determined, during the post-processing at locations without objects 113, because the respective radar data 103 at these locations is less influenced by reflections of the objects 113.

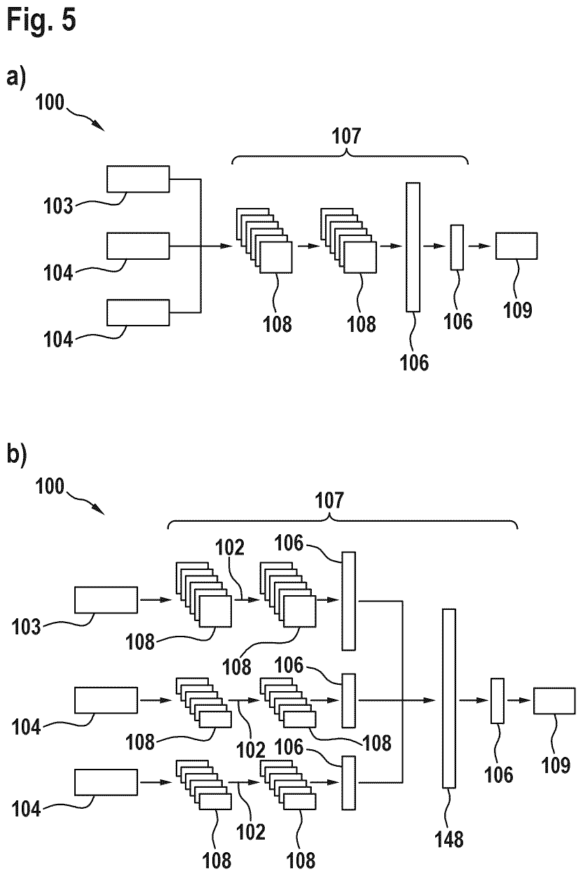

FIG. 5 shows a further schematic representation of the measuring device 100 according to a further embodiment.

Graphs a) and b) of FIG. 5 show two different alternatives of joint data processing of radar data 103 and additional sensor information 104 by the diagnostic module 107.

Graph b) illustrates a joint processing of the radar data 103 and the additional sensor information 104 of the additional sensors by the diagnostic module 107. For this purpose, the radar data 103 and the additional sensor information 104 are collectively used as input data of the diagnostic module 107 configured as an artificial intelligence, in particular as an artificial neural network. The diagnostic module 107 here comprises multiple convolutions 108 and multiple dense layers 106. The radar data 103 and the additional sensor information 104 are processed jointly as input data via the convolutions 108 and dense layers 106. The aforementioned diagnostic results 109 are created as output data of the diagnostic module 107 based on this.

On the other hand, in graph b) the radar data 103 and the additional sensor information 104 are used as stand-alone input data of the diagnostic module 107. The diagnostic module 107 becomes multiple processing paths 102. The processing paths 102 each comprise multiple convolutions 108 and at least one dense layer 106. In the various processing paths 102, wall diagnostics are performed separately by the diagnostic module 107 based on the radar data 103 and the additional sensor information 104, respectively.

In an additional concatenation layer 148, the partial results of the partial diagnostics of the different processing paths 102 are combined and fed to a final dense layer 106. The output data of the diagnostic module 107 corresponds to the diagnostic results 109 described above.

The correspondingly configured diagnostic module 107 is configured to perform wall diagnostics as described above, including the features described above, based on the radar data 103 and the additional sensor information 104.

In the embodiment shown, the diagnostic module 107 is configured as an artificial neural network, in particular as a convolutional network. Corresponding network architectures with convolutions 108, dense layers 106, and concatenation layers 148 are known from prior art.

1. A measuring device, comprising:
at least one radar sensor unit configured to provide radar data of a wall for which diagnostics are to be performed;
a diagnostic module configured to perform wall diagnostics based on the radar data and to generate diagnostic results; and
a display unit configured to display the diagnostic results to a user of the measuring device,
wherein the diagnostic module is configured to detect an object formed in the wall based on the radar data, and
wherein the detecting of the object comprises a determination of an object position and a classification of an object type for the object.

2. The measuring device according to claim 1, wherein the diagnostic module is further configured to determine an object depth of the object within the wall based on the radar data, the object depth being defined by a distance of the object formed in the wall to a surface of the wall.

3. The measuring device according to claim 1, wherein the diagnostic module is further configured to determine an object extension of the object in a predefined direction based on the radar data.

4. The measuring device according to claim 1, wherein the diagnostic module is further configured to classify a wall type of the wall based on the radar data.

5. The measuring device according to claim 4, wherein the diagnostic module is further configured to perform a subsurface correction for object recognition based on the classification of the wall type.

6. The measuring device according to claim 1, wherein the display unit is configured to display to the user the object position of the object in the wall and at least one of a type class of the object type of the object, an object depth, an object extension of the object, and a type class of a wall type of the wall as the diagnostic results.

7. The measuring device according to claim 4, the diagnostic module comprising:
at least one pre-processing module configured to pre-process the radar data of the radar sensor unit and provide input data;
a wall type classification module configured to classify the wall type of the wall based on the input data provided by the at least one pre-processing module; and
an object recognition module configured to detect the object formed in the wall and to classify the respective object type of the object based on the input data provided by the at least one pre-processing module.

8. The measuring device according to claim 7, wherein:
the at least one pre-processing module comprises a first pre-processing module and a second pre-processing module,
wherein the first pre-processing module is configured to pre-process the radar data of the radar sensor unit and provide the input data for the wall type classification module,
wherein the wall type classification module is configured to classify the wall type of the wall based on the input data provided by the first pre-processing module and provide wall type information to the second pre-processing module,
wherein the second pre-processing module is configured to pre-process the radar data of the radar sensor unit and, taking into account the wall type information of the wall type classification module, provide the input data to the object recognition module, and
wherein the object recognition module is configured to detect the object formed in the wall and classify the respective object type of the object based on the input data provided by the second pre-processing module.

9. The measuring device according to claim 1, further comprising:
at least one of an induction sensor, an eddy current sensor, a capacitance sensor, an AC current sensor, a nuclear magnetic resonance (NMR) sensor, and an ultrasonic sensor configured to provide additional sensor data,
wherein the diagnostic module is configured to perform the wall diagnostics by taking into account the additional sensor data.

10. The measuring device according to claim 1, wherein the diagnostic module further comprises at least one correspondingly trained artificial intelligence configured to perform object recognition and/or a wall classification and/or an object depth determination based on the radar data and/or additional sensor data.

11. The measuring device according to claim 1, further comprising:
a motion detection unit configured to sense a movement of the measuring device along a surface of the wall.

12. The measuring device according to claim 1, wherein:
the classification of the object type includes classifying the object as at least one selected from the group consisting of: metallic or non-metallic object, low voltage cable, single phase AC signal cable, multiphase AC signal cable, wood beam, metal beam, plastic pipe, water filled plastic pipe, fresh water pipe, non-water filled plastic pipe, and waste water pipe.

13. The measuring device according to claim 6, wherein the wall type classification module is configured to classify the wall type as one or more selected from the group consisting of: concrete wall, plasterboard/drywall wall, brick wall and/or bricks of the wall, underfloor heating, and wall heating.
